(19) United States
(12) Patent Application Publication
(10) Pub. No.: US 2010/0150007 A1
(43) Pub. Date: Jun. 17, 2010

(54) METHOD FOR TRANSMITTING AND RECEIVING CHANNEL QUALITY INFORMAITON IN MULTI CARRIER WIRELESS SYSTEM

(76) Inventors: Soo-Jung Jung, Daejon (JP); kyoung-Seok Lee, Daejon (KR); Byung_Han Ryu, Daejon (KR)

Correspondence Address: STAAS & HALSEY LLP, SUITE 700, 1201 NEW YORK AVENUE, N.W., WASHINGTON, DC, 20005, US

(21) Appl. No.: 12/513,065

(22) PCT Filed: Oct. 29, 2007
(86) PCT No.: PCT/KR2007/005355

§ 371 Date: Feb. 17, 2010

(30) Foreign Application Priority Data
Oct. 31, 2006 (KR) 10-2006-0106165

(51) Int. Cl. H04J 1/16; H04W 4/00

(52) U.S. Cl. 370/252; 370/329

(57) ABSTRACT

Provided is a method for transmitting and receiving a channel quality indicator (CQI) in a multi carrier wireless system which does not increase load while efficiently feeding back a change of the channel quality. The method for transmitting the channel quality indicator in a Orthogonal Frequency Division Multiple Access (OFDMA)-based terminal, includes the steps of: a) transmitting a first report indicator requesting transmission of a measured channel quality indicator to a base station through a control channel when a change range of a channel quality indicator is greater than a predetermined threshold value; and b) transmitting the measured channel quality indicator to the base station through allocated radio resources when a response to the first report indicator is received from the base station.

### TECHNICAL FIELD

The present invention relates to a method for transmitting and receiving a channel quality indicator (CQI); and, more particularly, to a method for transmitting a channel quality indicator including a time-varying channel characteristic to a base station in a technology for feeding back a channel quality indicator in a multi carrier wireless system such as an Orthogonal Frequency Division Multiple Access (OFDMA) communication system.

This work was supported by the IT R&D program for

MIC/IITA [2005-S-404-12, “Research & Development, of Radio Transmission Technology for 3G evolution”].

### BACKGROUND ART

An initial wireless communication was developed to provide a voice service. As a technology advances, however, technologies for providing a data service are being developed. Increase in requests of data transmission and the number of user terminals calls for technologies for efficient data transmission. Therefore, a wireless communication system requires each user terminal to exactly grasp a channel condition between a base station and the user terminal/receive and transmit data.

Since a Wideband Code Division Multiple Access (WCDMA) communication system spreads and transmits all user's data through an entire band, there is only one channel quality value with respect to a channel of the entire band. The user terminal acquires control information such as the number of retransmission responses, a feedback period of a channel quality value, the number of repeated transmissions of the channel quality value, and power offset in advance by communicating with a base station in order to transmit the channel quality value and data. The terminal to make a call continuously monitors High Speed Shared Control Channel (HS-SCCH) while periodically transmitting channel quality values through High Speed Dedicated Control Channel (HS-DPCCH). When the terminal finds the control information required for receiving data, the terminal receives the data through forward High Speed Packet Data Shared Channel (HS-PDSCH) based on the control information.

Meanwhile, the 3rd Generation Partnership Project (3GPP) in charge of standardization is now working on Long Term Evolution (LTE). The LTE is a technology for realizing 100 Mbps high-speed packet based-communication and is scheduled to be commercialized by 2010. At present, the 3GPP is considering to apply Orthogonal Frequency Division Multiple Access (OFDMA) method to the LTE.

The OFDMA technology is a method for transmitting data based on multi carrier. That is, the OFDMA technology is a method for converting symbol sequences inputted in series into parallel symbol sequences, modulating them into a plurality of sub-carriers having an orthogonal property, and transmitting the sub-carriers.

The OFDMA system requires channel quality indicator (CQI) which is fed back from the terminal in order to adaptively allocate and use radio resources according to the wireless environment of the terminals for efficient use of the radio resources. The channel quality indicator is fed back through a control channel shared by a plurality of terminals.

For example, a user terminal in the OFDMA system measures selected parameters in a reception signal. The parameters measured in the user terminal and calculation values acquired from the selectively measured parameters are fed back to the base station through a standard message, which is called a channel quality indicator (CQI). Accordingly, the base station optimizes signals transmitted through the forward channel based on the channel quality indicator, thereby increasing a reception performance and quality in the user terminal.

Since the radio channel generally varies according to time, user terminals are required to feed back variance of channel quality to the base station for optimal performance whenever the channel quality is changed. However, feedback of the channel quality indicator should be performed in consideration of load according to use of up-link resources for feedback and other users.

Conventionally, terminals periodically feed back channel quality indicators to the base station according to a period determined for each terminal. Another method is for the terminals to feed back the channel quality indicators to the base station only upon receipt of a request from the base station. The method that the terminal periodically feeds back the channel quality indicator has an advantage that an additional control signal is not required. However, there are shortcomings that the time-varying channel characteristic is not fed back to the base station and that the channel quality indicator is fed back even though there is no change in channel. Also, the method of feeding back the channel quality indicator upon receipt of a request from the base station requires an additional control signal. Moreover, in the base station, the controls about the feedback operation of the channel quality information with a terminal and up-link resource are required.

### DISCLOSURE

### Technical Problem

An embodiment of the present invention is directed to providing a method for transmitting and receiving a channel quality indicator which efficiently feeds back change of a channel quality and prevents increase of load by complementing shortcomings of conventional technologies of feeding back a channel quality indicator in a multi carrier wireless system.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a method for transmitting the channel quality indicator in a Orthogonal Frequency

Division Multiple Access (OFDMA)-based terminal, including the steps of: a) transmitting a first report indicator requesting transmission of a measured channel quality indicator to a base station through a control channel when a change range of a channel quality indicator is greater than a predetermined threshold value; and b) transmitting the measured channel quality indicator to the base station through allocated radio resources when a response to the first report indicator is received from the base station.

The transmitting method in accordance with the present invention further includes the step of: transmitting a second report indicator notifying that there is no feedback of the measured channel quality indicator for a predetermined period to the base station when there is no change of the measured channel quality indicator for a predetermined period.

The transmitting method in accordance with the present invention further includes the step of: transmitting the measured channel quality indicator to the base station through the allocated radio resources when a measurement time of the channel quality indicator coincides with a feedback time of the channel quality indicator.

The first report indicator is transmitted to the base station only when the terminal communicates data with the base station in up-link or down-link.

In accordance with another aspect of the present invention, there is provided a method for receiving a channel quality indicator in a wireless communication base station, including the steps of: a) receiving a first report indicator requesting transmission of a measured channel quality indicator when a change range of the measured channel quality indicator through a control channel is greater than a predetermined threshold value; b) transmitting response information for feedback of the measured channel quality indicator to a terminal; and c) when the measured channel quality indicator is received based on the response information, storing the received channel quality indicator.

The receiving method in accordance with the present invention further includes the step of: when the second report indicator notifying that there is no feedback of the measured channel quality indicator for a predetermined period through the control channel is received, setting up allocated radio resources as available radio resources in order to feed back the channel quality indicator from the terminal.

In a feedback technology of a down-link channel quality indicator that a terminal transmits in up-link in the OFDMA-based packet wireless communication system, the present invention can feed back change in channel to the base station according to characteristics of the channel which is changed according to a time by request of the terminal and control of the base station based on the method for periodically feeding back the channel quality indicator in order to ensure exactness of the channel quality indicator and applicability of limited wireless resources based on the method for periodically feeding back the channel quality indicator. Also, the present invention does not perform feedback when there is no change in channel according to a time. Accordingly, the present invention can improve performance of the system and applicability of the limited wireless resources by efficiently transmitting the down-link channel quality indicator directly affecting the performance of the system according to change in channel.

### Advantageous Effects

As described above, a technology for feeding back a channel quality indicator about down-link is needed for efficient use of radio resources in an OFDMA communication system for packet transmission. When compared to a conventional periodic channel quality indicator feedback method, the channel quality indicator feedback method of the present invention does not require an additional control channel and can properly feed back a channel quality indicator according to a change in a channel environment without increasing the amount of resources used for feeding back the channel quality indicator by using a report indicator, which is transmitted from a user terminal, and a control information response thereto, which is transmitted from a base station.

### BRIEF DESCRIPTION OF THE DRAWINGS

FIG. 1 is a block diagram showing a terminal in accordance with an embodiment of the present invention.

FIG. 2 is a flowchart describing a process for transmitting a channel quality indicator in the terminal in accordance with an embodiment of the present invention.

FIG. 3 is a flowchart describing a process of receiving the channel quality indicators in a base station in accordance with an embodiment of the present invention.

### BEST MODE FOR THE INVENTION

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

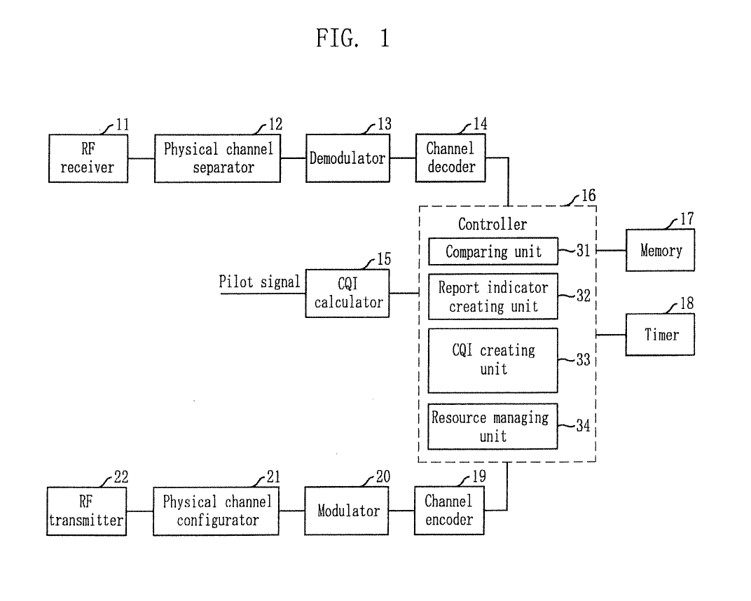

FIG. 1 is a block diagram showing a terminal in accordance with an embodiment of the present invention. The terminal in accordance with the present invention is an Orthogonal Frequency Division Multiple Access (OFDMA)-based terminal which herein operates as a transmitter for transmitting a channel quality indicator.

Referring to FIG. 1, a Radio Frequency (RF) signal receiver 11 converts received RF signals into baseband signals, and provides them to a physical channel separator 12. The physical channel separator 12 generally includes a cyclic prefix (CP) remover, a serial/parallel converter, a Fast Fourier Transformer (FFT), and a parallel/serial converter. The cyclic prefix (CP) remover removes a cyclic prefix (CP) symbol inserted for a guard interval from received OFDM symbols, and generates serial baseband signals in a time domain. The serial/parallel converter converts baseband signals of time domain into parallel signals of time domain. An N-sized FFT implements the FFT algorithm to generate N parallel frequency-domain signals. The parallel/serial converter converts the parallel frequency-domain signals into a QAM data symbol sequence.

The demodulator 13 demodulates the QAM symbols and restores an original input data stream. Further, a channel decoder 14 implements channel decoding over data inputted from the demodulator 13 to provide the decoded data to a controller 16.

A channel quality indicator (CQI) calculator 15 generates channel quality indicator values by using an OFDM-based common pilot channel signal received from a base station. At the same time, the channel quality indicator calculator 15 receives various parameters, and uses a channel quality indicator table obtained in advance.

A channel encoder 19 is a functional block implementing channel encoding, and it receives a predetermined information bit stream from the controller 16 and implements the channel encoding. In general, the channel encoder 19 may be a convolutional encoder, a turbo encoder, or a low density parity check (LDPC) encoder.

The modulator 20 implements modulation such as the Quadrature Phase Shift Keying (QPSK), BPSK, 16-ary Quadrature Amplitude Modulation (16 QAM), 64 QAM, and 256 QAM.

A physical channel configurator 21 includes a serial/parallel converter, an Inverse Fast Fourier Transformer (IFFT), a parallel/serial converter and a cyclic prefix (CP) inserter. The serial/parallel converter receives and converts output of the modulator into parallel data. The N-sized IFFT receives the output data of the serial/parallel converter and implements an IFFT algorithm. The output data of the IFFT is converted into serial data in the parallel/serial converter. The CP inserter inserts a CP symbol into the output data of the parallel/serial converter.

The controller 16 transmits a report indicator to a base station through a control channel when channel quality is changed over a predetermined threshold value although a time for feeding back a channel quality indicator has not come yet. Also, the controller 16 transmits the report indicator to the base station through the control channel when a change in channel quality is under a predetermined threshold value for a predetermined period and the channel quality value is not changed.

Accordingly, the controller 16 includes a comparing unit 31, a report indicator creating unit 32, a channel quality indicator creating unit 33, and a resource managing unit 34. The comparing unit 31 compares a channel quality indicator measured with a previous channel quality indicator calculator 15 and the channel quality indicator measured to figure out whether the difference between the two is greater than a threshold value. The report indicator creating unit 32 creates a first report indicator for requesting transmission of the measured channel quality indicator when the difference of the channel quality indicators is greater than the threshold value, or creates a second report indicator for notifying that there is no feedback of the channel quality indicator for a predetermined period when the difference between the channel quality indicators is smaller than the threshold value and there is no change in the channel quality for a predetermined period. The channel quality indicator creating unit 33 creates a channel quality indicator to be transmitted to the base station upon receipt of a response from the base station to the first report indicator and or upon coincidence of the feedback period and the measurement period. The resource managing unit 34 manages a channel for transmitting the first and second report indicators and a channel for transmitting the channel quality indicator. The controller 16 may also control a memory 17 and a timer 18.

The report indicator may be expressed as a specific value. In other words, the controller 16 transmits the first report indicator to be transmitted when the channel quality is changed greater than the threshold value, and the second report indicator to be transmitted when there is no change in the channel quality for a predetermined period in the same format indicators but different values, thereby making the base station distinguish the first and second report indicators be divided by their value.

Operation of the controller 16 will be described in detail hereinafter. When the channel quality is changed over the threshold value at a channel condition measurement time, the controller 16 transmits the report indicator to the base station through the control channel. When the channel condition measurement time coincides with the pre-determined feedback period of the channel quality indicator, the controller 16 does not transmit the report indicator but transmits the measured channel quality indicator to the base station for a feedback period.

Also, when the change range of the channel quality for a predetermined period is smaller than the threshold value, the controller 16 transmits the report indicator to the base station and notifies that there is no feedback on the channel quality for a predetermined period. When the base station receives the report indicator for notifying that there is no feedback on the channel quality for a predetermined period, the base station manages control channel resources used to the feedback period of the terminal as available resources.

The report indicator that the terminal transmits to the base station in connection with feedback of the channel quality indicator may be transmitted through the following up-link channels.

When down-link data are transmitted from the base station to the terminal, a down-link data-associated feedback control channel, e.g., an acknowledgement/non-acknowledgement (ACK/NACK) information transmission channel, is used in hybrid automatic repeat request (HARQ). When the down-link data are not transmitted to the terminal, a following channel may be used according to whether the terminal transmits data in the up-link. When the data are transmitted in the up-link, an up-link data transmission associated control channel is used. When the data are not transmitted in the up-link, it means that there is no data transmission in the up/down-link. Accordingly, since it is not efficient to feed back change in a channel environment from the terminal, the report indicator is not transmitted.

The base station manages and allocates a change in radio resources for feedback of a channel quality indicator generated in response to the report indicator from the terminals. When the base station receives the report indicator from the terminal in a moment when it is not a feedback period of the channel quality indicator according to change in channel, the base station transmits a response including transmission resource information and/or positive and negative responses ACK/NACK information bit to the terminal.

That is, when there are available shared channel resources because, for example, the feedback period of another terminal is changed, the base station receiving the report indicator from the terminal transmits ACK as positive response information on the received report indicator and the channel resource information for the terminal transmitting the channel quality indicator to the base station. When the base station also receives the report indicator for notifying that there is no change in channel for a predetermined period, the base station figures out that there is no channel quality feedback from the terminal for a predetermined period and manages a change in the channel resources for feeding back the channel quality indicator.

When the transmission resource information of the response information follows a rule predetermined in the system, the transmission resource information may include only the ACK/NACK information bit without additional information. That is, when up-link radio resources for transmitting the channel quality indicator is determined by a rule pre-decided by the system, the base station does not transmit to the terminal resource information for transmitting the channel quality indicator.

Following down-link channels may be considered in case of the control response information of the base station associated with the report indicator transmitted from the terminal. When the data are transmitted to the terminal in the down-link, a down-link data associated control channel is used. When the data are transmitted from the terminal not in the down-link but in the up-link, up-link data associated feedback control channel, e.g., an HARQ ACK/NACK information transmission channel, is used.

Meanwhile, the base station sets up the feedback period of panel quality information which is different according to each terminal and transmits the feedback period of panel quality information to the terminals, and designates a measurement period for measuring a channel quality indicator by the terminal within the feedback period. The feedback period and the measurement period have a relation of multiple numbers.

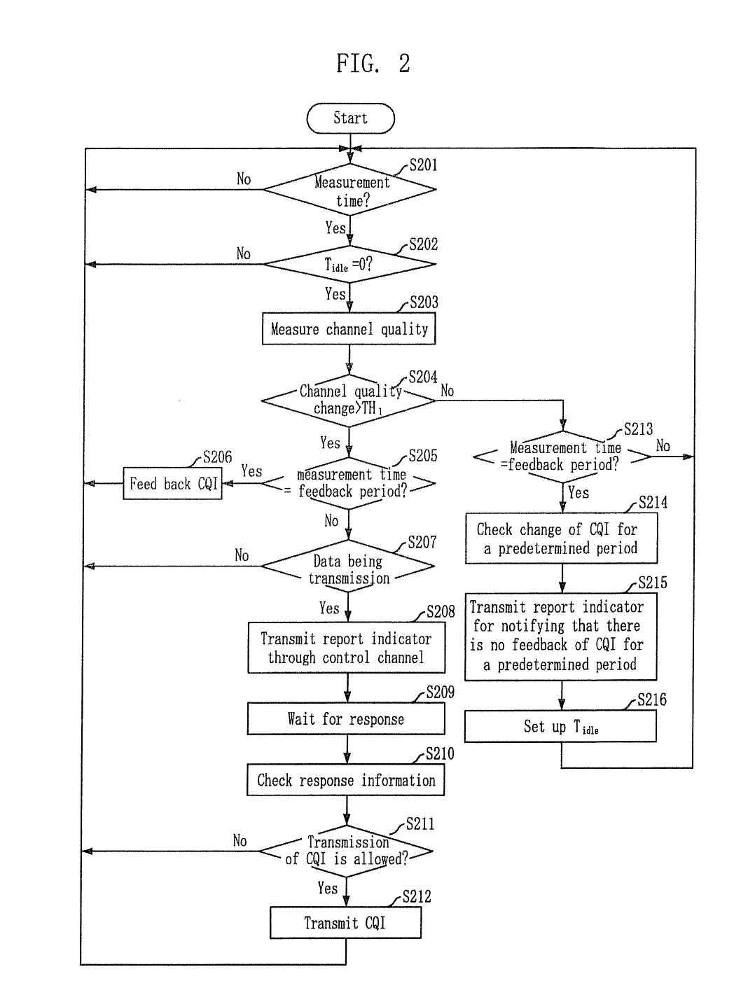

FIG. 2 is a flowchart describing a process for feedback of a channel quality indicator in the terminal in accordance with an embodiment of the present invention.

When a measurement time comes according to a predetermined measurement period at step S201, the terminal checks at step S202 whether the first timer T_{idle} associated with a time when feedback on the channel quality indicator is not performed is in operation. That is, since feedback is not performed on the channel quality indicator in case that the first timer value is not ‘0’, there is no need to measure the channel quality when the first timer value is not ‘0’. However, since the first timer does not operated in case that the first timer value is ‘0’, the terminal checks whether there is a change of the channel quality at steps S203 and S204 by measuring the channel quality. That is, it is checked whether a difference between a currently measured channel quality value and a channel quality value measured in a former measurement period is smaller or greater than a predetermined threshold value TN₁.

When the change of the channel quality is greater than the predetermined threshold value at step S204, it is checked at step S205 whether the measurement time coincides with the feedback period of the channel quality indicator. When the measurement time coincides with the feedback period of the channel quality indicator, the channel quality indicator is fed back to the base station at step S206. However, when the measurement time does not coincide with the feedback period of the channel quality indicator, it is checked at step S207 whether there is data transmission between the base station and the terminal in the up-link or the down-link.

When the data are transmitted in the up-link or the down-link, the terminal selects a proper control channel and transmits the first report indicator for requesting transmission of the channel quality indicator to the base station at step S208. The terminal transmitting the first report indicator waits for a response and checks response information for the first report indicator transmitted from the base station at step S210.

The terminal checks the response information transmitted from the base station and transmits the channel quality indicator changed through the radio resources allocated for feedback at step S212 in case that the base station allows transmission of the channel quality indicator at step S211. When there is no available channel resource in the base station, the base station does not allow feedback of the channel quality indicator for the terminal and the terminal does not transmit the channel quality indicator to the base station. Therefore, the channel quality indicator of the terminal is not changed in the base station.

Meanwhile, when the change of the channel quality is smaller than a predetermined threshold value at step S204, it is checked first whether the measurement time coincides with the feedback period at step S213. When the measurement time coincides with the feedback period, the extent of the change of the channel quality indicator for a predetermined period is checked at step S214. When the change of the channel quality indicator for the predetermined period is small, the terminal transmits to the base station the second report indicator for notifying that there is no feedback of the channel quality indicator for a predetermined period to the base station at step S215. The terminal sets up the first timer T_{idle} as a predetermined value, and sets up the channel quality indicator not to be transmitted for the set-up time. The set up timer value is a value known to the base station and all terminals.

A process of receiving in the base station the first and second report indicators from the terminal will be described.

Generally, the base station may include an RF receiver, a physical channel separator, a demodulator, a channel decoder, a controller, a data channel configurator, a control channel configurator and an RF transmitter, which are not shown in the drawing.

The RF receiver receives signals transmitted from the terminal through an antenna, converts the signals into baseband signals, and inputs the baseband signals into the physical channel separator. The physical channel separator extracts the channel quality indicator and inputs the channel quality indicator into the demodulator. The physical channel separator extracts external control information and backward data. The demodulator demodulates the channel quality indicator according to a predetermined method, inputs the channel quality indicator into the channel decoder. The channel decoder extracts the channel quality indicator through a channel decoding procedure. The extracted channel quality indicator is inputted into the controller.

The controller generally includes a channel quality indicator controller, a scheduler and a power controller. The scheduler performs scheduling based on the channel quality indicator inputted from the channel quality indicator controller and other scheduling informations. After the scheduler performs scheduling, the scheduler notifies a scheduling result to the data channel configurator, and has a data channel be configured through a predetermined procedure. Also, the scheduling result is inputted into the control channel configurator such that packet data control information corresponding to the scheduling result can be transmitted. Also, the scheduling result is inputted into the power controller. The power controller receives the channel quality indicator scheduled by the scheduler and performs power control on the data channel configurator. Also, the power controller performs power control on the control channel configurator.

The data channel configurator determines transmission power based on the data to be transmitted to each terminal and the information of the power controller creates data and outputs the data to the RF transmitter. Also, the control channel configurator configures a control signal to be transmitted to each terminal or entire terminals as a control channel, receives information of the transmission power on the control signal to be transmitted to each terminal from the power controller, and outputs the information of the transmission power to the RF transmitter.

In the base station as described above, the receiving apparatus of the channel quality indicator in accordance with the present invention includes a radio resource manager, a channel quality indicator controller and a report indicator processor. The radio resource manager manages radio resources. The channel quality indicator controller stores and manages the channel quality indicator transmitted from the terminal. The report indicator processor transmits to the terminal response information allowing transmission of the measured channel quality indicator through the radio resource manager only when there are available radio resources; the first report indicator requesting transmission of the measured channel quality indicator is received; and the change of the channel quality indicator measured before the feedback of the channel quality indicator is greater than a predetermined threshold value. When the second report indicator notifying that there is no feedback of the channel quality indicator for a predetermined period is received, the report indicator processor notifies the radio resource manager to establish the radio resources allocated for feedback of the channel quality indicator of the terminal for the predetermined period as available radio resources.

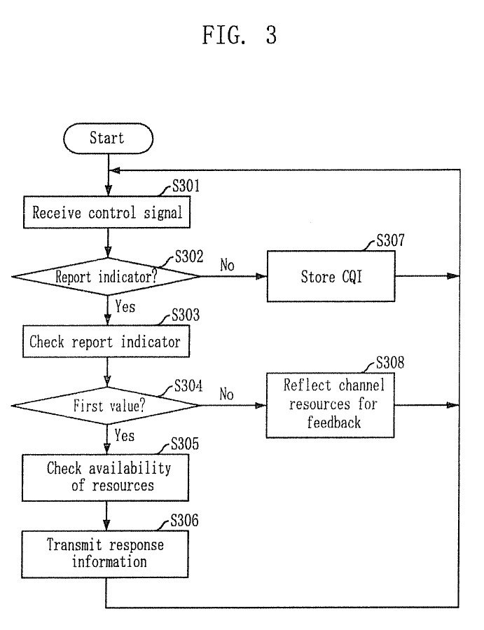

A typical process of the base station in accordance with the present invention will be described with reference to FIG. 3.

FIG. 3 is a flowchart describing a process of receiving the first and second report indicators in the base station in accordance with an embodiment of the present invention.

When the base station receives a control signal from the terminal at step S301, the base station checks at step S302 whether the information included in the received control signal is a report indicator or a channel quality indicator.

When the received information is the report indicator at the step S302, the base station checks at step S303 whether the report indicator is the first report indicator requesting transmission of the channel quality indicator, or the second report indicator notifying that the channel quality indicator is not transmitted for a predetermined period.

When the received report indicator is the first report indicator requesting transmission of the channel quality indicator at step S304, the base station checks at step S305 whether there are shared radio channel resources available because, for example, the feedback period of another user terminal is changed. When there are the available radio resources, the base station transmits channel resource information capable of transmitting the channel quality indicator and/or response information including positive response to the terminal at step S306. However, when there is no available radio resource, NACK can be transmitted. Meanwhile, the base station may not transmit the radio resource information when the terminal transmits the channel quality indicator through radio resources predetermined by the system according to a rule.

Meanwhile, when the report indicator received from the terminal is the second report indicator notifying that the channel quality indicator is not transmitted for a predetermined time at step S304, the base station reflects channel resources for feedback of the channel quality indicator of the terminal as available channel resources since there is no feedback of the channel quality indicator from the terminal for a predetermined period at step S308.

Meanwhile, when the channel quality indicator is received from the terminal, the base station stores the channel quality indicator of the terminal at step S307 to use the channel quality indicator for power control and scheduling.

As described above, the technology of the present invention can be realized as a program. Codes and code segments forming the program can be easily inferred by a computer programmer of the related field. Also, the realized program can be stored in a computer-readable recording medium, i.e., information storage, and is read and executed by the computer, thereby realizing the method of the present invention. The recording medium includes all types of recording media which can be read by computers.

While the present invention has been described with respect to certain preferred embodiments, it will be apparent to those skilled in the art that various changes and modifications may be made without departing from the scope of the invention as defined in the following claims.

### INDUSTRIAL APPLICABILITY

As described above, the present invention is applied to an efficient feedback technology of a channel quality indicator (CQI) in down-link required for radio resources in an Orthogonal Frequency Division Multiple Access (OFDMA) communication system for packet transmission.

1. A method for transmitting a channel quality indicator in a wireless communication terminal, comprising the steps of:
a) transmitting a first report indicator requesting transmission of a measured channel quality indicator to a base station through a control channel when a change of a channel quality indicator is greater than a predetermined threshold value; and
b) transmitting the measured channel quality indicator to the base station through allocated radio resources when a response to the first report indicator is received from the base station.

2. The transmitting method of claim 1, further comprising the step of:
c) transmitting a second report indicator notifying that there is no feedback of the measured channel quality indicator for a predetermined period to the base station when there is no change of the measured channel quality indicator for a predetermined period.

3. The transmitting method of claim 1, further comprising the step of:
d) transmitting the measured channel quality indicator to the base station through the allocated radio resources when a measurement of the channel quality indicator coincides with a feedback of the channel quality indicator.

4. The transmitting method of claim 2, further comprising the step of:
setting up a timer value in order not to feed back the measured channel quality indicator for a predetermined period after the step c).

5. The transmitting method of claim 2, wherein in the step a), the first report indicator is transmitted to the base station only when the terminal communicates data with the base station in up-link or down-link.

6. The transmitting method of claim 5, wherein when the terminal receives down-link data, the first report indicator is transmitted to the base station through a data-associated feedback control channel.

7. The transmitting method of claim 5, wherein when the terminal does not receive down-link data, but transmits up-link data, the first report indicator is transmitted to the base station through an up-link data transmission associated control channel.

8. The transmitting method of claim 2, wherein in the step b), only when transmission of the measured channel quality indicator is allowed, the measured channel quality indicator is transmitted to the base station based on radio resource information included in the response to the first report indicator.

9. A method for receiving a channel quality indicator in a wireless communication base station, comprising the steps of:
a) receiving a first report indicator requesting transmission of a measured channel quality indicator when a change of the measured channel quality indicator through a control channel is greater than a predetermined threshold value;
b) transmitting response information for feedback of the measured channel quality indicator to a terminal; and
c) when the measured channel quality indicator is received based on the response information, storing the received channel quality indicator.

10. The receiving method of claim 9, further comprising the step of:
d) when the second report indicator notifying that there is no feedback of the measured channel quality indicator for a predetermined period through the control channel is received, setting up allocated radio resources as available radio resources in order to feed back the channel quality indicator for the terminal.

11. The receiving method of claim 10, wherein the step b) includes the steps of:
checking whether there are available radio resources for feedback of the measured channel quality indicator;
allocating radio resources for feedback of the measured channel quality indicator when there are the available radio resources;
transmitting response information including the allocated radio resource information and information allowing feedback of the measured channel quality indicator to the terminal; and
transmitting response information not allowing feedback of the measured channel quality indicator to the terminal when there is no available radio resource.

12. The receiving method of claim 10, wherein in the step b), the response information includes a positive/negative response bit.

13. The receiving method of claim 12, wherein in the step b), the response information further includes radio resource information allocated for feedback of the channel quality indicator.
